(19) United States
(12) Patent Application Publication
(10) Pub. No.: US 2013/0323136 A1
(43) Pub. Date: Dec. 5, 2013

(54) POWER SUPPLY ARRANGEMENT WITH AN INVERTER FOR PRODUCING A SINGLE-PHASE ALTERNATING CURRENT

(71) Applicant: AEG POWER SOLUTIONS B.V., Zwanenburg (NL)

(72) Inventor: Andreas Averberg, Bonn (DE)

(73) Assignee: AEG POWER SOLUTIONS B.V., Zwanenburg (NL)

(21) Appl. No.: 13/750,021

(22) Filed: Jan. 25, 2013

(30) Foreign Application Priority Data
Jun. 1, 2012 (EP) 12 170 482.9

(51) Int. Cl. H02M 3/335

(52) U.S. Cl. CPC H02M 3/33569
USPC 422/199; 363/17

(57) ABSTRACT

Power supply arrangement with inverter (3) generating single-phase AC current and transformer (4) having primary winding (41) and first secondary winding (421) and second secondary winding (422). The secondary windings (421, 422) have same number of turns and are arranged to be permeated by same magnetic flux during operation of transformer (4), so that identical voltages are tapped at secondary windings (421, 422) during operation of the transformer (4). A respective terminal of first secondary winding (421) and a respective terminal of second secondary winding (422) are connected to one another at first point (K1), that two-phase system whose phases are shifted by 180° relative to each other is produced between first point (K1), additional terminal of first secondary winding (421) and additional terminal of second secondary winding 422). First point (K1) is connected to neutral conductor terminal (N) of output of power supply arrangement via capacitor.

This application claims priority to EP 12 170 482.9 filed on Jun. 1, 2012.

### BACKGROUND OF THE INVENTION

The present invention relates to a power supply arrangement with an inverter for producing a single-phase alternating current, and a transformer having a primary winding and a first secondary winding and a second secondary winding, wherein the secondary windings have the same number of turns and are arranged so that they are permeated during operation of the transformer by the same magnetic flux, so that equal voltages can be tapped at the secondary windings during operation of the transformer, wherein a respective terminal of the first secondary winding and a respective terminal of the second secondary winding are connected with one another at a first point, such that a two-phase system having phases that are shifted relative to each other by 180° is obtained between the first point, an additional terminal of the first secondary winding and an additional terminal of the second secondary winding.

The document EP 2 346 150 A1 discloses such power supply arrangement (see FIG. 1b therein). The same document discloses the use of this first power supply arrangement for supplying power to silicon rods for producing polysilicon according to the Siemens process. The power supply arrangements illustrated in FIG. 1b of the aforementioned document EP 2 346 150 A1 each have two outputs at which voltages phase-shifted by 180°, i.e. voltages of opposite phase, are provided. These voltages supply medium frequency currents with a frequency between 1 and 1000 kHz to the silicon rods. The voltages of opposite phase are produced by two transformers which each have a primary winding and two secondary windings. The secondary windings are connected together at a first node. The first nodes are each connected to a neutral conductor terminal of the outputs of the power supply arrangements. Other terminals of the secondary windings are connected to the phase conductor terminals of the outputs.

In addition to the power supplied from the first power supply arrangements, the silicon rods can be supplied with power, as described in the document EP 2 346 150 A1, from a second power supply arrangement at the same time they are supplied with power from the first power supply arrangements. In this second power supply arrangement, the silicon rods are connected in series. The current from the second power supply arrangement has a frequency of about 50 Hz.

The document EP 2 346 150 A1 discloses that the first power supply arrangement and the second power supply arrangement are decoupled from one another by capacitors. For this purpose, capacitors are employed between the phase conductor terminals of the outputs and the other terminals of the secondary windings of the transformers. These capacitors form, in conjunction with other components, high pass filters, which prevent current supplied from the second power supply arrangement to flow into the first power supply arrangements which could damage or even destroy the first power supply arrangements. Conversely, the second power supply arrangement is decoupled from the first power supply arrangements, because the voltage at an output of a first power supply arrangement is compensated by the voltage of opposite phase at the other output of the same first power-supply arrangement.

In practice, however, problems may arise when the loads at the outputs of a first power supply arrangement are not of identical size. Especially when the inductance of the one load is greater than the inductance of the other load, significant differences in the magnitudes of the voltages provided at the outputs of the first power supply assemblies may arise. As a result, this sum of the voltages across the outputs of the first power supply arrangement is then no longer 0 V. Instead, magnitudes of more than 100 V are reached. The attained voltage may depend on the frequency at which the first power supply arrangement is operated.

This uneven loading of the first power supply arrangement and the resulting voltage across the series-connected outputs of the first power supply arrangement may lead to damage or destruction of the second power supply arrangement.

### BRIEF SUMMARY OF THE INVENTION

It is therefore an object of the invention to improve a first power supply arrangement so as to eliminate differences between the magnitudes of the voltages at the outputs of an aforementioned first power supply arrangement as much as possible.

This object is attained with the invention in that a capacitor is arranged in series with the primary winding of the transformer or between the first node and the neutral conductor terminal of an output of the power supply arrangement.

The capacitor connecting the first node to the neutral conductor terminal or the capacitor arranged in series opposite to the primary winding capacitor is, during operation of the power supply arrangement, connected directly or indirectly, i.e. by interconnecting the transformer, both in the electrical circuit with the first secondary winding as well as in the electrical circuit of the second secondary winding of the power supply arrangement. The capacitor can thus compensate the difference in magnitude between the voltages at the outputs of the power supply arrangement. The capacitor, in particular when the capacitor is located on the secondary side, may have a capacitance of 2 to 10 μF, and in particular of 4.5 μF.

The equivalence of the arrangement of the capacitor in series with the primary winding of the transformer, on one hand, and between the first node and the neutral conductor terminal, on the other hand, becomes clear when the transformer is mentally replaced by an equivalent circuit. A person skilled in the art will then realize that also the capacitor arranged on the primary side acts in both load circuits.

The additional terminal of the first secondary winding is preferably connected to a first phase conductor terminal and the additional terminal of the second secondary winding is preferably connected to a second phase conductor terminal. With the invention, the voltage between the phase conductor terminals is then greatly reduced compared to the state of the art.

For example, the phase conductors may conceivably be connected directly to the other terminals of the secondary windings. The voltage between the phase conductor terminals can then be 0 V or close to 0 V even when the outputs of the power supply arrangement have an unbalanced load, in particular for resistive-inductive loading with unequal inductive load components.

It is also conceivable to connect the phase conductor terminals via capacitors to the additional terminals of the secondary windings. The voltage between the phase conductors can then also be reduced with unbalanced loading of the outputs of the power supply arrangement. However, the reduction is not as evident as in a situation where these capacitors at the phase conductor terminals are omitted.

The object can also be attained according to the invention in that the voltage across at least one of the secondary windings is discretely or continuously adjustable. A discrete adjustment of the voltage can be achieved when at least one of the secondary windings has several taps. When the voltage across at least one of the secondary windings is adjustable, it can be changed so that the voltages across the loads connected to the power supply arrangement according to the invention have the same magnitude.

According to another solution of the invention, capacitors may be arranged between the other terminals of the secondary windings and phase conductor terminals of the output, wherein at least one of the capacitors has an adjustable capacitance. Such variable capacitor may also make the voltages across the loads connected to the power supply arrangement according to the invention equal in magnitude.

The inverter may be an H-bridge having power transistors.

The power supply arrangement may include a frequency converter and the inverter may be part of the frequency converter. In addition to the inverter, the frequency converter may include a rectifier and a DC link circuit.

Alternatively, the frequency converter may also be a direct converter. The inverter within the context of this application is then an integral part of the direct converter.

The power supply arrangement according to the invention may be part of a reactor for producing polysilicon according to the Siemens process. The power supply arrangement according to the invention may be a first power supply arrangement for supplying AC power to silicon rods or thin silicon rods for inductive heating. The silicon rods or thin silicon rods may be arranged in a reactor vessel. Holders for retaining the silicon rods or thin silicon rods are provided in the reactor vessel. The holders are simultaneously electrical terminals, with which the silicon rods or thin silicon rods are integrated into the load circuit.

The reactor may include a second power supply arrangement for supplying AC power to the silicon rods or thin silicon rods for inductive heating. This second power supply arrangement may include a transformer having a plurality of secondary-side taps and power controllers connected thereto, which are operated in voltage sequence control and are connected to a phase conductor terminal of the second power supply arrangement, as is also disclosed, for example, in the document EP 2 346 150 A1. A frequency of an AC current that can be generated by the first power supply arrangement is between 1 to 1000 kHz, and a frequency of the AC current that can be generated by the second power supply arrangement is 10 to 100 Hz

### BRIEF DESCRIPTION OF THE DRAWINGS

Additional features of the invention will become apparent from the following description of preferred exemplary embodiments with reference to the appended drawings, which show in

FIG. 1 a circuit diagram of a power supply arrangement according to the prior art,

FIG. 2 a circuit diagram of a first power supply arrangement according to the invention, and

FIG. 3 a circuit diagram of a second power supply arrangement according to the invention.

### DETAILED DESCRIPTION OF THE INVENTION

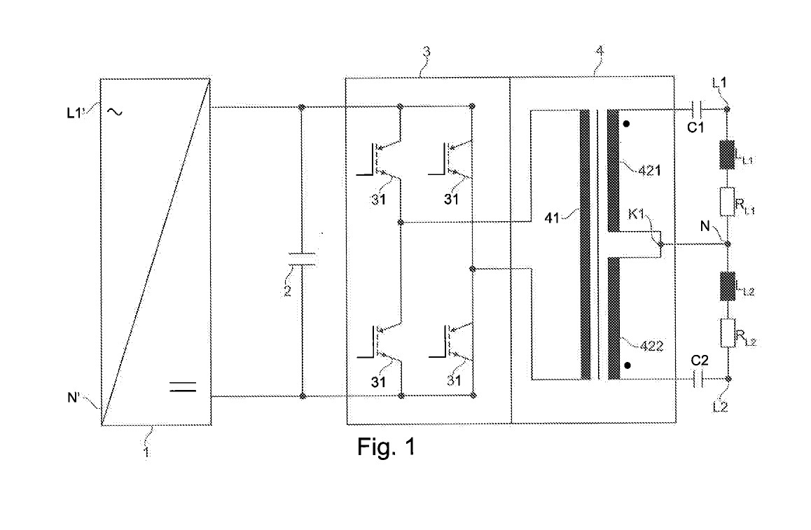

The power supply arrangement according to the prior art shown in FIG. 1 includes a frequency converter with a rectifier 1, a DC link circuit 2 and an inverter 3.

The rectifier 1 is connected to a phase conductor L1′ and to a neutral conductor N′ of a power grid. A capacitor which forms the DC link circuit 2 is connected to the output of the rectifier. The inverter 3 is connected to the DC link circuit 2.

The inverter 3 is an H-bridge formed of IGBTs 31, as are commonly used in inverters. Other controllable switches can be used instead of IGBTs. A primary winding 41 of a transformer 4 is connected in the transverse branch of the H-bridge. The transformer 4 has on the secondary side two windings 421, 422. The two secondary windings are arranged on a core and are permeated by the same magnetic flux. The secondary windings 421, 422 have the same number of turns, but are wound in opposite directions.

A respective terminal of one secondary winding and a respective terminal of the other secondary winding are brought together at a single point K1. An electrical connection to a neutral conductor terminal N at an output side of the power supply arrangement is made from this node.

An additional terminal of each of the secondary windings 421, 422 is connected via a respective capacitor C1, C2 to a phase conductor terminal L1, L2 on the output side of the power supply arrangement.

The power supply assembly supplies at its outputs L1, N and L2, N two voltages with opposite phases, which have identical magnitude in idle and when the outputs L1, N, L2, N are symmetrically loaded. The voltage between the phase conductors L1, L2 is then 0 V.

The magnitudes of the two outputs L1, N, L2, N may become different due to asymmetric loading of the outputs. The voltage between the phase conductors L1, L2 is then not 0 V. Depending on the frequency of the AC voltages on the outputs and depending on the type of the load, the magnitude of the deviation may be so large so as to cause problems for the incorporation of the power supply assembly into a larger facility. The AC voltages may diverge during operation of the power supply arrangement particularly for different inductive loads. Large voltages may be produced between the phase conductor terminals L1 and L2 in particular when the power supply arrangement supplies, during operation, AC voltages with frequencies that are close to the resonance frequencies of the output circuits, which include the secondary coil 421, the capacitor C1, the load RL1, LL1 or the secondary coil 422, the capacitor C2, and the load RL2, LL2.

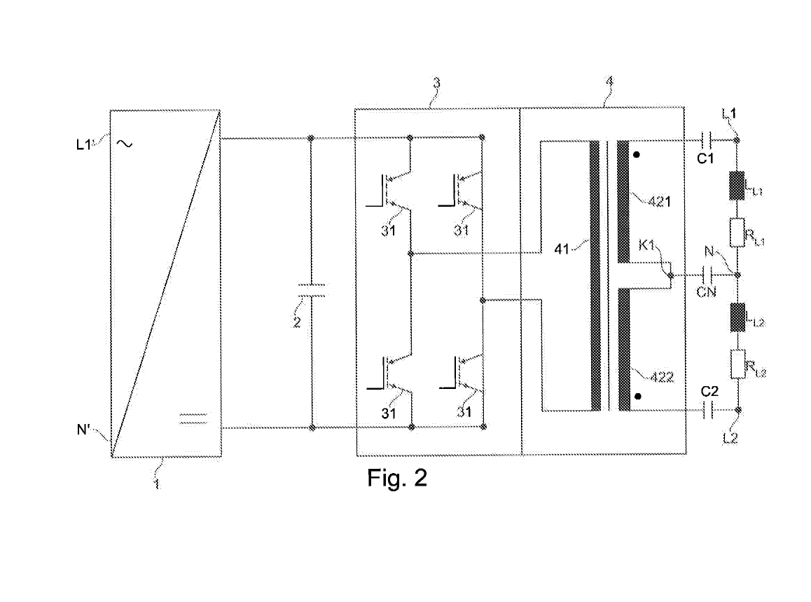

These voltages can be reduced considerably by interconnecting a capacitor CN in the connection between the point K1 and the neutral conductor terminal N, like in the first power supply arrangement according to the invention illustrated in FIG. 2, which otherwise corresponds to the power supply arrangement according to FIG. 1.

The capacitor CN causes coupling between the output circuits, which in turn reduces the voltage between the phase conductor terminals L1, L2. The voltages at the outputs L1, N, L2, N are compensated compared to the cases described with reference to FIG. 1 for asymmetric loading. The voltages can be reduced by up to about 80%.

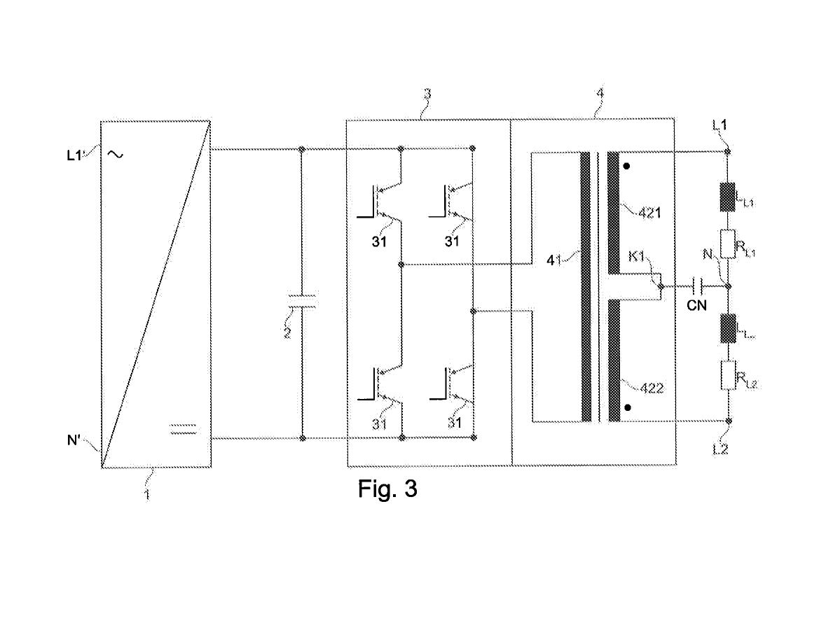

An reduction of the voltage between the phase conductors by almost 100% can be achieved for an asymmetrical, in particular an asymmetric resistive-inductive load, on the outputs L1, N, L2, N by replacing the capacitors C1 and C2 in the connections between the additional terminals of the secondary windings 421, 422 of the transformer 4 and the phase conductor terminals L1, L2 with conductive connections, and by arranging only the capacitor CN between the first point K1 and the neutral conductor terminal, as is illustrated in FIG. 3 for the second circuit arrangement according to the invention, which otherwise corresponds to the first circuit arrangement according to the invention depicted in FIG. 2.

What is claimed is:

1. A power supply arrangement comprising
an inverter (3) for producing single-phase AC current and a transformer (4) having a primary winding (41) and a first secondary winding (421) and a second secondary winding (422), wherein the secondary windings (421, 422) have an identical number of turns and are arranged so that they are permeated by the same magnetic flux during operation of the transformer (4), so that identical voltages can be tapped at the secondary windings (421, 422) during operation of the transformer (4), wherein a respective terminal of the first secondary winding (421) and a respective terminal of the second secondary winding (422) are connected to one another at a first point (K1), that a two-phase system, whose phases are shifted relative to each other by 180°, is obtained between the first point (K1), an additional terminal of the first secondary winding (421) and an additional terminal of the secondary winding (422),
wherein the first point (K1) is connected to a neutral conductor terminal (N) of an output of the power supply arrangement via a capacitor,
wherein a capacitor is arranged in series with the primary winding of the transformer,
wherein the voltage across at least one of the secondary windings is discretely or continuously adjustable, and/or capacitors are provided between the additional terminals of the secondary windings and the phase conductor terminals of the output, wherein at least one of the capacitors has an adjustable capacitance.

2. The power supply arrangement according to claim 1, wherein the additional terminal of the first secondary winding (421) is connected to a first phase conductor terminal (L1) and the additional terminal of the second secondary winding (422) is connected to a second phase conductor terminal (L2).

3. The power supply arrangement according to claim 2, wherein a capacitor (C1) is connected between the additional terminal of the first secondary winding (421) and the first phase conductor terminal (L1), and that a capacitor (C2) is connected between the additional terminal of the second secondary winding (422) and the second phase conductor terminal L2).

4. The power supply arrangement according to claim 1, wherein the inverter (3) is an H-bridge comprising power transistors (31).

5. The power supply arrangement according to claim 1, wherein the power supply arrangement includes a frequency converter (1, 2, 3) and the inverter (3) is part of the frequency converter (1, 2, 3).

6. A reactor for producing polysilicon according to the Siemens process, comprising
a first power supply arrangement for supplying power to silicon rods with AC current for inductive heating, wherein the first power supply arrangement is a power supply arrangement according to claim 1.

7. A reactor according to claim 6, wherein the reactor has a second power supply arrangement for supplying power in form of AC current for inductive heating to the silicon rods, wherein a frequency of the AC current that is produced by the first power-supply arrangement is about 10 to about 1000 kHz, and a frequency of the AC current that can be produced by the second power supply arrangement is about 10 to about 100 Hz.

8. A reactor according to claim 6, wherein the silicon rods are thin silicon rods which can be arranged inside a reactor vessel.
